(19) United States
(12) Patent Application Publication
(10) Pub. No.: US 2003/0014504 A1
(43) Pub. Date: Jan. 16, 2003

(54) Method and apparatus for dynamic common gateway interface Web site management

(76) Inventors: Christopher L. Hess, Phoenix, AZ (US); Kelley A. Kent, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/896,214

(22) Filed: Jun. 29, 2001

(51) Int. Cl. G06F 15/16; G06F 15/177

(52) U.S. Cl. 709/220; 709/218

(57) ABSTRACT

A method and apparatus for dynamic common gateway interface Web site management are disclosed. Phase control configuration data for a Web site including two or more sections is first stored and then utilized to dispatch one of the sections. The Web site may then be modified in response to an alteration of the phase control configuration data. In one embodiment, the phase control configuration data specifies an order and dispatching one of the sections includes selecting the section using the order and displaying a Web page via a Web browser client application across a communications network in response to the selection. The phase control configuration data may then specify input data to be collected by the selected section. According to this embodiment, the specified input data is then collected using a phase control module.

### FIELD OF THE INVENTION

The invention relates generally to the field of computer systems. More particularly, the invention relates to a method and apparatus for dynamic common gateway interface Web site management.

### BACKGROUND

Computer networks such as intranets, extranets, the Internet, and particularly the World Wide Web (WWW) have developed into a convenient communication medium. A document or “Web page” created using the Hypertext Markup Language (HTML) is provided by a Web server application across a network to a Web browser client application for display in response to a request containing the Uniform Resource Locator (URL) address of the requested page. Although only static data could be initially made available via such Web pages, numerous methods have recently been developed by which dynamic content including forms, gateways, virtual documents, and Web-based applications may be provided. Dynamic content may be provided using a variety of mechanisms such as Dynamic HTML, Active Server Pages (ASPs), Javascript, JAVA, application program interfaces (APIs), and the Common Gateway Interface (CGI).

CGI is a specification which defines an interface between a CGI application or “action” and an information server such as a Hypertext Transfer Protocol (HTTP) or Web server. A request for a CGI application looks much like a request for a static Web document but contains the URL address of a CGI program or script rather than of an HTML file. A Web server application identifies a CGI application request (typically by the location of the file or its file extension) and attempts to execute the contents of the requested file and return its output instead of returning the file contents verbatim. Web pages generated by a CGI application in this way or which contain a URL link or “tag” to request execution of a CGI application are therefore called “CGI pages”. Although the CGI interface provides a more interactive and generally more useful user experience, it suffers from drawbacks which make the creation, management, and control of Web sites including CGI application references difficult.

Conventional CGI applications include sections of data collection code to collect incoming data (i.e. data sent from another Web page), data manipulation code to process collected data, and page display code to display dynamically-generated content. One significant drawback associated with CGI is that, as part of the HTTP protocol, CGI is “stateless” meaning that data collected for one CGI application execution is not maintained from one client request to the next. CGI applications must therefore typically be designed specifically to collect and manipulate the data received by an immediately preceding Web page. Similarly, when CGI applications are successively linked, the page display section of each CGI-generated page must specify an appropriate CGI application to collect and process the data (if any) received. The order and content of CGI pages within conventional Web sites have therefore been by necessity predefined and static making the management of such Web sites exceedingly difficult and time-consuming.

### BRIEF DESCRIPTION OF THE DRAWINGS

The present invention is illustrated by way of example and not limitation in the figures of the accompanying drawings, in which:

FIG. 1 illustrates a communications network according to an embodiment of the present invention;

FIG. 2 illustrates an exemplary computer system block diagram according to an embodiment of the present invention;

FIG. 3 illustrates the contents of a memory of server computer system 100 of FIG. 1 according to one embodiment of the present invention;

FIG. 4 illustrates a phase control module block diagram according to an embodiment of the present invention;

FIG. 5 illustrates a high-level process flow diagram for one embodiment of the present invention; and

FIGS. 6a and 6b illustrate site map diagrams for a Web site prior to and following an alteration to Web site flow is made utilizing one embodiment of the present invention.

### DETAILED DESCRIPTION

A method and apparatus for dynamic common gateway interface Web site management are described herein. In the following detailed description, numerous specific details such as specific computer system or phase control module architectures are set forth in order to provide a more thorough understanding of the present invention. It should be evident however, that these specific details need not be used to practice the present invention. In other circumstances, well-known data structures, system elements, or connections have been omitted or have not been described in particular detail in order to avoid unnecessarily obscuring the present invention.

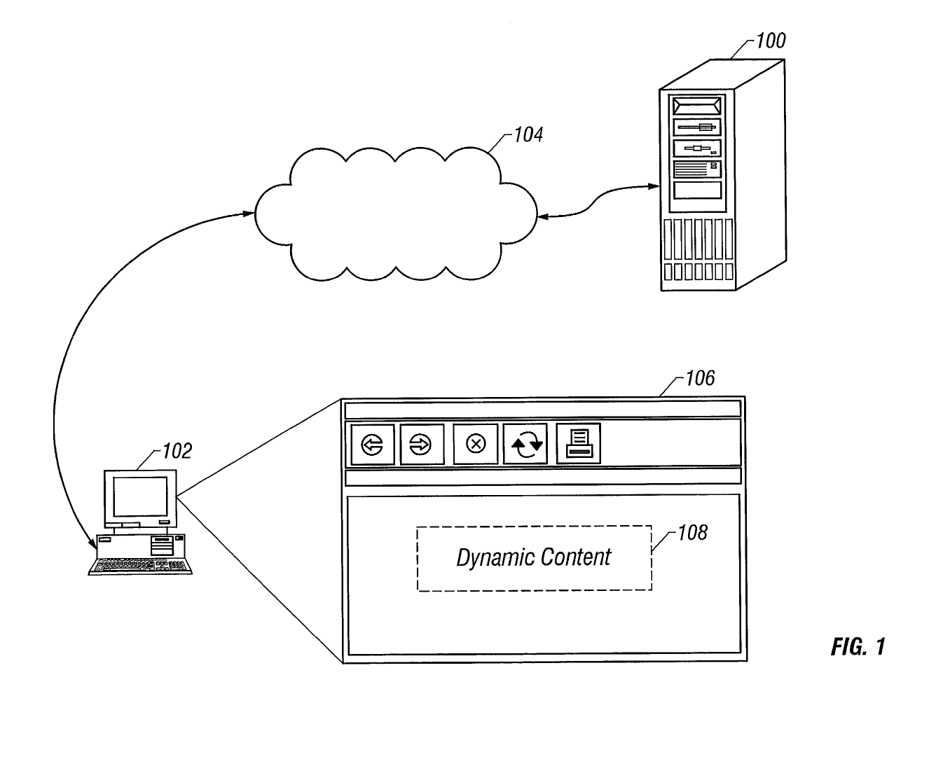

FIG. 1 illustrates a communications network according an embodiment of the present invention. In the illustrated network, a server computer system 100 including a phase control module according to one embodiment of the present invention communicates with a client computer system 102 via a communications network 104 to provide access to a Web site. In one embodiment, the Web site includes a plurality of phases and a plurality of sections within each phase. A phase is a set or collection of Web pages within a Web site grouped together by common functionality or order. Each phase is self-contained and independent of prior or subsequent phases but may be dependent on the completion of a prior phase to facilitate a phase order. Each section is associated with a Web page which may contain static or dynamic content 108 such as an interactive form for receiving user data. In one embodiment, each section is associated with a single, distinct Web page. However, alternative embodiments in which a section is associated with more than one Web page in order to facilitate the use of frames or provide variable page granularity and in which different sections are associated with identical Web pages are also contemplated.

Communication network 104 may be organized as either a wide area network (WAN) covering a large geographic area or a local area network (LAN) which encompasses, by comparison, a smaller physical region. Wide area networks may include conventional network backbones, long-haul telephone lines, Internet service providers, various bridges, gateways, routers, and other conventional means for routing data between computers. Communication network 104 may be private, for use by members of a particular company or organization, in which case the network is described as an intranet, or public, as for example, a portion of the Internet such as the World Wide Web (WWW). In one embodiment, communications network 104 comprises a LAN. In an alternative embodiment, communications network 104 comprises a WAN such as the WWW portion of the Internet, or a proprietary network such as America Online™, Compuserve™, Microsoft Network™, and/or Prodigy™.

Returning to the illustrated embodiment, a Web browser client application 106 executing on client computer system 102 is utilized to submit a request including a URL address to a Web server application within server computer system 100. Server computer system 100 receives the URL address-containing request via its Web server application and then utilizes the included phase control module and Web server application to responsively provide content such as dynamic content 108. After the request is received, the phase control module within server computer system 100 determines the appropriate phase and section based on the Web browser client application request. The correct section is then dispatched to Web browser client application 106 via the Web server application within server 100.

In one embodiment, the phase control module may be utilized regardless of whether static content (such as plain text or static HTML) or dynamic content (such as a CGI application-generated page or redirection command) is requested. In another embodiment of the present invention, the phase control module is only utilized for requests containing the URL address of a CGI application within the provided Web site. If the requested URL references a static HTML document or “Web page” within the Web site, the document is simply provided by the Web server application across communications network 104 to client Web browser application 106 for display. The phase control module may be implemented in software, hardware, or firmware in various embodiments of the present invention.

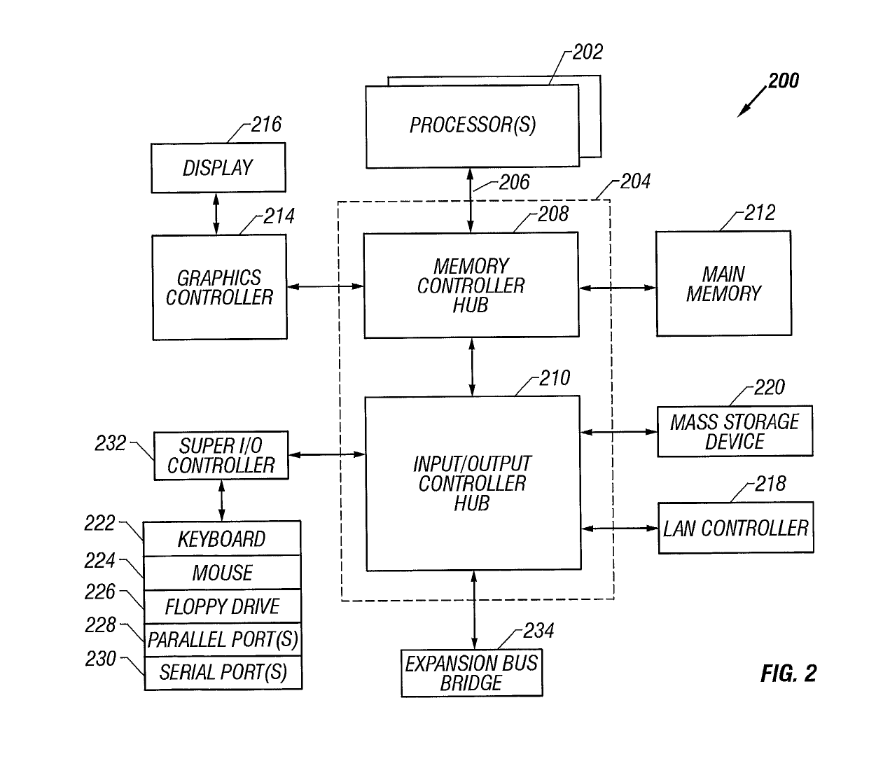

FIG. 2 illustrates an exemplary computer system block diagram according to an embodiment of the present invention. Although described in the context of computer system 200, the present invention may be implemented in any suitable data processing system having a greater or lesser number of system components. For example, client computer system 102 of FIG. 1 may, in alternative embodiments of the invention, comprise a workstation, personal computer, “thin client” (i.e. network computer or NetPC), Internet appliance, terminal, palmtop computing device, robust cellular or Personal Communications Services (PCS) telephone, or the like. Similarly, server computer system 100 of FIG. 1 may comprise a wide variety of data processing systems. For example, in one embodiment of the present invention server computer system 100 comprises a network-attached storage (NAS) device.

A conventional NAS device is a thin server (sometimes called an appliance server, application server, or specialty server) coupled with one or more mass storage devices to provide additional storage space on a communications network. Although the number, type, and capacity of the storage devices used can vary, an array of hard disk storage devices is typically used. For example, in one embodiment the mass storage devices comprise a RAID (Redundant Array of Inexpensive Disks) system. NAS devices allow more hard disk storage space to be added to a network without shutting down a system or enterprise server for maintenance and upgrades.

Administering a NAS device (creating shared folders, user management, TCP/IP settings, setting date & time, etc.) is typically accomplished through Web pages that reside on the NAS device itself (a secure Web server may be implemented on the NAS device). This allows a system administrator to remotely configure the NAS device from any computer on the same network by opening a Web browser to the NAS device location. During first-time use of the NAS device (i.e. initial power-on), there is certain data to be collected from the user in order to setup the device properly. The process of collecting this data is known as “End User Setup”.

In one embodiment, the present invention is implemented for the NAS device End User Setup. The data to be collected during End User Setup is organized into similar groupings or phases such as “Welcome Screen”, “Networking Settings”, “Sharing”, “System Settings”, and “Conclusion Screen”. Each phase includes one or more sections, for example in one embodiment, the Networking Settings phase, includes two sections: TCP/IP Settings and E-mail. Each section in turn is associated with one or more Web pages used to collect various user data. To each phase, an order is assigned. In one embodiment, phases are ordered so that Phase 1 occurs before Phase 2, and so on. Sections follow an identical approach. The phases and the sections within each phase may then be dispatched in their respective orders (e.g. Section 1 of Phase 1, Section 2 of Phase 1, Section 1 of Phase 2, Section 1 of Phase 3, etc.) and this order may then be altered to control the order or “flow” of a Web site.

As illustrated in FIG. 2, computer system 200 comprises one or more processors 202 and a chipset 204 coupled to a processor system bus 206. Processor(s) 202 may each comprise any suitable processor architecture and for one embodiment comprise an Intel™ Architecture, used for example, in the Pentium™ family of processors available from Intel™ Corporation of Santa Clara, Calif. Chipset 204 for one embodiment of the present invention comprises a “north bridge” or memory controller hub (MCH) 208 and a “south bridge” or input/output (I/O) controller hub (ICH) 210 coupled together as shown. MCH 208 and ICH 210 may each comprise any suitable circuitry and for one embodiment, are each formed as a separate integrated circuit chip. Chipset 204 for other embodiments may comprise any suitable one or more integrated circuit or discrete devices.

MCH 208 may comprise a suitable interface controller to provide for any suitable communication link to processor system bus 206 and/or to any suitable device or component in communication with MCH 208. MCH 208 for one embodiment provides suitable arbitration, buffering, and coherency management for each interface.

MCH 208 is coupled to processor system bus 206 and provides an interface to processor(s) 202 over the processor system bus 206. Processor(s) 202 may, in alternative embodiments of the present invention be combined with MCH 208 to form a single chip. MCH 208 for one embodiment also provides an interface to a main memory 212 and a graphics controller 214 each coupled to MCH 208. Main memory 212 is capable of storing data and/or instructions executable on a processor such as processor 202 of computer system 200 and may comprise any suitable memory such as dynamic random access memory (DRAM) for example. Graphics controller 214 controls the display of information on a suitable display 216, such as a cathode ray tube (CRT) or liquid crystal display (LCD) for example, coupled to graphics controller 214. In the illustrated embodiment, MCH 208 interfaces with graphics controller 214 through an accelerated graphics port. However, it will be appreciated that the present invention may be practiced using any suitable graphics bus or port standard. Graphics controller 214 for one embodiment may alternatively be combined with MCH 208 to form a single chip.

MCH 208 is also coupled to ICH 210 to provide access to ICH 210 through a hub interface. ICH 210 provides an interface to I/O devices or peripheral components for computer system 200. ICH 210 may comprise any suitable interface controller to provide for any suitable communication link to MCH 208 and/or to any suitable device or component in communication with ICH 210. ICH 210 for one embodiment provides suitable buffering and arbitration for each interface.

In the illustrated embodiment, ICH 210 further provides an interface to a local area network (LAN) controller 218, a mass store device 220, and to a keyboard 222, a mouse 224, a floppy disk drive 226, as well as additional devices via one or more standard serial 228 or parallel 230 ports through a super I/O controller 232. LAN controller 218 or alternatively a modem codec (not illustrated) may be utilized to couple computer system 200 to a suitable communications network via various well-known methods. Mass store device 220 may comprise any suitable device or component to store data and/or instructions such as a tape or fixed disk magnetic storage device, or an optical storage device such as a compact disk (CD) or digital versatile disk (DVD) read only memory (ROM) device. In one embodiment of the present invention, mass store device 220 comprises one or more hard disk drives (HDD). In the illustrated embodiment, ICH 210 also provides an interface to an expansion bus bridge 234 to facilitate the attachment of additional I/O devices or peripheral components via an expansion bus such as a Peripheral Component Interconnect (PCI) or Industry Standard Architecture (ISA) bus (not illustrated).

The system of the present invention includes software, information processing hardware, and various processing operations, further described herein. The features and process operations of the present invention may be embodied in executable instructions embodied within a machine-readable medium such as main memory 212, mass store device 220, removable disk media coupled with floppy disk drive 226, a communications network available via LAN controller 218, or the like.

A machine-readable medium may include any mechanism that provides (i.e., stores and/or transmits) information in a form readable by a machine (e.g., computer system 200). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc. The instructions can be used to cause a general purpose or special purpose processor such as processor 202, programmed with the instructions, to perform methods or processes of the present invention. Alternatively, the features or operations of the present invention may be performed by specific hardware components that contain hard-wired logic for performing the operations, or by any combination of programmed computer components and custom hardware components.

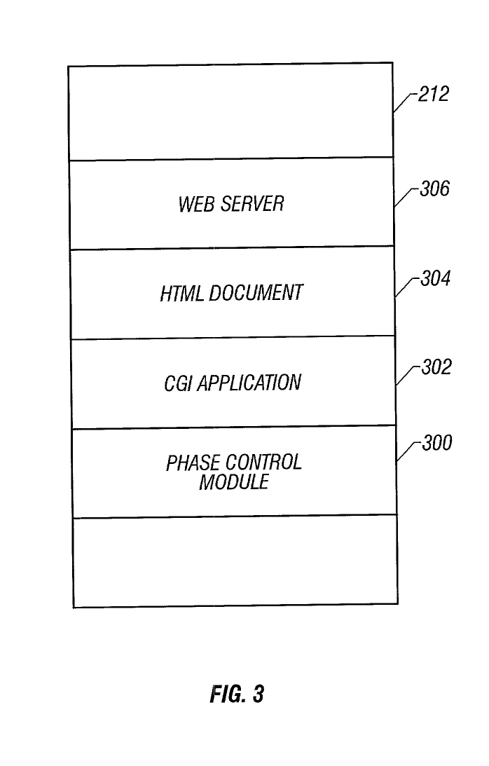

FIG. 3 illustrates the contents of a memory of server computer system 100 of FIG. 1 according to one embodiment of the present invention. It should be appreciated that no order or particular arrangement of the illustrated components is necessary or implied in order to implement the various embodiments of the present invention. In the illustrated embodiment, a phase control module according to the present invention is implemented as a software application or module comprising machine-executable instructions or program code. Main memory 212 of the embodiment depicted includes the phase control module application 300 as well as a Web server application 306 such as the Internet Information Server, which comes with the Windows NT server from Microsoft™ Corporation; the FastTrack and Enterprise server from Netscape Corporation; or Apache, a Web server for UNIX-based operating systems. Using multitasking operating systems and/or multiprocessor computer systems, the execution of both Web server 306 and phase control module application 300 may be interleaved giving the effective or apparent ability to execute them simultaneously.

Also included in memory 212 of the illustrated embodiment are one or more HTML documents or “Web page” files 304 and one or more CGI applications 302 according to the present invention. CGI applications 302 are typically transient, meaning they are initiated or called, execute, and then complete. CGI applications 302 may be made persistent however, using the FastCGI interface. FastCGI is essentially a program that manages multiple CGI application requests within a single persistent process rather than requiring a separate transient process for each request. Phase control module application 300 may similarly be persistent, or may be transient in an alternative embodiment and called or activated by Web server 306 in response to a Web browser client application CGI page request.

Unlike conventional, inter-dependent CGI applications, each CGI application 302 in the illustrated embodiment is autonomous, allowing CGI pages to be reordered, added, deleted, or otherwise modified without affecting other pages constituting the provided Web site or requiring numerous code changes to an individual modified CGI page. CGI applications 302 are made independent of one another by transferring the data collection function traditionally found in each CGI application to a phase control module 300. Additionally, in one embodiment of the present invention, data manipulation is additionally removed from individual CGI apps and incorporated into phase control module application 300. Resulting CGI applications 302 are therefore responsible solely for page display making them more modular and consequently making the creation, control, and management of such pages easier. In one embodiment this is accomplished by incorporating data collection and manipulation code sections into a library file that is called after each CGI page is loaded.

Page display itself is also simplified in the described embodiment as the phase control module 300 will be specified as the application to collect and process each CGI page's received data or “destination”. Accordingly, each CGI application 302 is made extremely modular and the flow and content of CGI applications 302 is dynamically modifiable unlike the predefined and static order and content requirements imposed by traditional CGI page structure where the order in which the pages are displayed is critical to correct Web site operation.

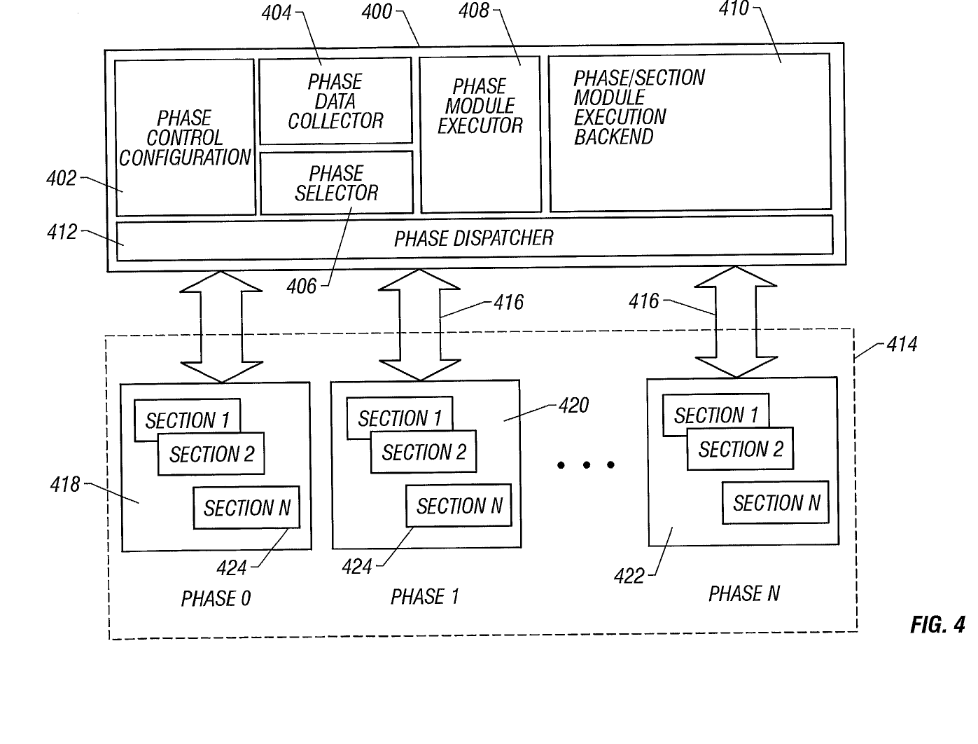

FIG. 4 illustrates a block diagram of phase control module such as phase control module 300 of FIG. 3 according to an embodiment of the present invention. In the illustrated embodiment, a phase control module 400 includes Phase Control Configuration Data 402, a Phase Data Collector 404, a Phase Selector 406, a Phase Module Executor 408, Phase/Section Module Execution Backend Code 410, and a Phase Dispatcher 412. While a software-implemented embodiment of phase control module 400 resident within a memory such as main memory 212 of FIG. 2 will be described with reference to the presently described illustration, it should be appreciated that phase control module 400 may be implemented in software, hardware, firmware or any combination thereof in alternative embodiments of the present invention.

In one embodiment, for example, Phase Control Configuration Data 402 and Phase/Section Module Execution Backend Code 410 may be stored in a memory device while Phase Data Collector 404, Phase Selector 406, Phase Module Executor 408, and Phase Dispatcher 412 may be implemented in one or more dedicated hardware devices. Similarly, although a single main memory 212 has been previously described, specialized or dedicated individual memory devices may be utilized for some or each of the described system elements. Phase control module 400 interacts with a Web site 414 including one or more phases 418-422, via CGI application/page requests and responses 416. Phases 418-422 in turn include one or more sections 424 each of which is associated with a Web page of Web site 414 used to display content as well as to receive data from users accessing the site 414.

Phase Control Configuration Data 402 includes one or more configuration files describing the number, layout, order or “flow”, content, etc. of phases, sections and Web pages for Web sites such as Web site 414 managed using phase control module 400. Phase Control Configuration Data 402 is provided to Phase Selector 406 and used to determine what section is to be dispatched, and consequently which page is to be displayed after the current section. In one embodiment, each phase includes its own associated Phase Control Configuration Data 402 file. In another embodiment, Phase Control Configuration Data 402 specifies an order of phases 418-422 and sections 424 which is used to select the next section 424 to be dispatched. Similarly, Phase Control Configuration Data 402 is utilized to provide Phase Data Collector 404 with information on what data needs to be collected from each page within a section 424. In one embodiment of the present invention, Phase Control Configuration Data 402 may be modified to cause a modification of the flow and/or content of Web site 414 using phase control module 400.

Phase Selector 406 is the logic module behind which phase or section is dispatched next. Based on input from Phase Module Executor 408, Phase Control Configuration Data 402, and Phase Dispatcher 412, Phase Selector 406 directs the activity of phase control module 400 by determining whether to execute Phase/Section Module Execution Backend Code 410, selecting the next section 424 to be dispatched, and notifying Phase Dispatcher 412 of its selection to indicate which Web page is to be displayed. Phase Dispatcher 412 is the component within phase control module 400 which performs the actual calling/dispatching of phases and sections. Once a section has been selected for dispatch by Phase Selector 406, Phase Dispatcher 412 retrieves a corresponding Web page or other content and sends the retrieved data to the requesting Web browser client application via a Web server application.

Once a section is posted/completed (i.e. once the expected data has been received by a given Web page and the “submit” or “enter” button has been actuated), Phase Data Collector 404 imports the data from that page and stores it for later processing. In one embodiment, manipulation or processing of collected data occurs at the end of each phase. In an alternative embodiment of the present invention, such processing is performed on the fly at the end of each section. Phase Data Collector 404 interfaces with the Phase Control Configuration Data 402 to determine which data is to be collected so that it is retrieved and stored properly. Collected data may include explicitly user-provided input data such as form entries transmitted within a QUERY_STRING environment variable or standard input stream as well as implicitly provided input data obtained using various other environment variables such as the server's hostname or IP address (SERVER_NAME) or the URL of the document that the Web browser client pointed to before accessing the CGI application (HTTP_REFERER).

Phase Module Executor 408 calls the appropriate code to process the data collected by Phase Data Collector 404. If Phase Selector 406 determines that Phase/Section Module Execution Backend Code 410 needs to be executed, it initiates a call to the Phase Module Executor 408 in order to begin this execution. To do so, Phase Module Executor 408 makes hooked calls with input from the Phase Data Collector 404 into the Phase/Section Module Execution Backend 410. The backend will then report back a success or failure which the Phase Module Executor 408 then passes to Phase Selector 406. Phase Selector 406 may utilize the reported success or failure to further direct the activity of phase control module 400. According to alternative embodiments of the present invention, Phase/Section Module Execution Backend Code 410 may be executed upon completion of either a phase or section dispatch to facilitate Web page/site operation. Phase Module Executor 408 includes hooks in order to make the calls into Phase/Section Module Execution Backend 410 possible. Upon completion, Phase/Section Module Execution Backend Code 410 reports a success or failure of the code's execution to the Phase Module Executor 408.

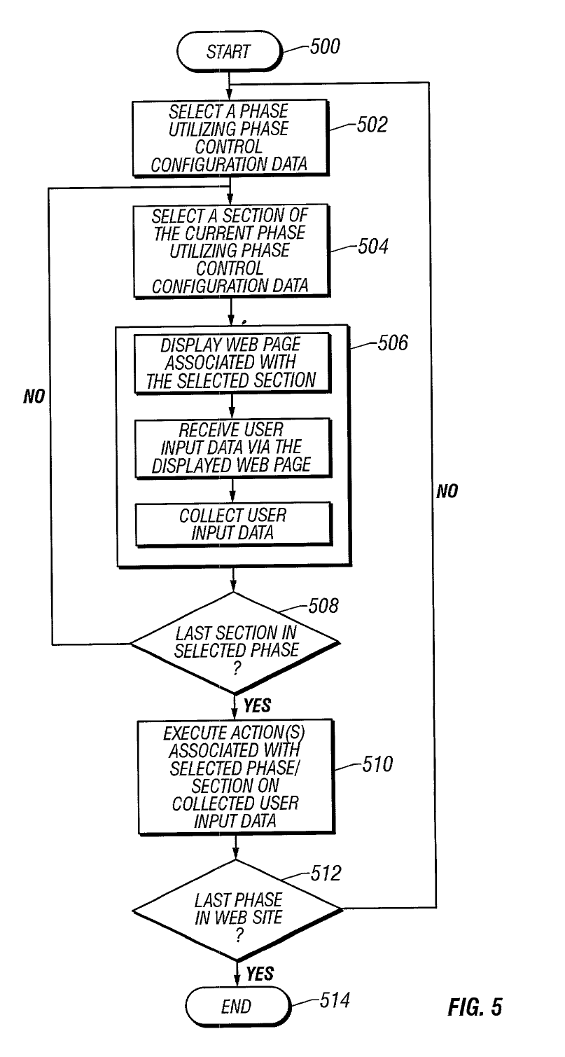

FIG. 5 illustrates a high-level process flow diagram for one embodiment of the present invention. The illustrated process begins (block 500) with the initialization of Phase Control Configuration Data previously executed or collected by a prior user Web site access. Next, a phase of the provided Web site is selected utilizing stored phase control configuration data (block 502). The Phase Selector selects which phase to begin collecting data in based in part on the initialization process since the phase control module may be starting from a user's initial access of the Web site or continuing at a point where a user might have left off previously. In the latter case, the Phase Selector will be notified of any previous accesses and the user will be given an option to continue where he/she left off or start over from the beginning.

Thereafter, a section is selected also using stored phase control configuration data from within the previously selected or “current” phase (block 504). The Phase Selector selects which section to begin at starting with section zero unless phase control configuration data indicates that the user exited previously from a section greater than zero in a previous access, in which case the Phase Selector will be notified to start deeper within the phase beginning at the last known accessed section. Next, in the illustrated embodiment, a Web page associated with the selected section is displayed, user input data is received if necessary via the displayed Web page, and received data (if any) is collected for subsequent processing (block 506). To receive input data in the illustrated embodiment, control is turned over to the user until all data is entered and the user clicks a “next” or “submit” button to post the data back to the Web server application. Control is then returned to the Phase Dispatcher which in turn hands off control to the Phase Data Collector. In collecting received data the Phase Data Collector utilizes the Phase Control Configuration Data to determine what data it needs to collect from this particular section within the current phase enabling it to retrieve and store it appropriately.

With respect to the present invention, the use of the term “receiving” may encompass one or more actions or operations achieved via or for a displayed Web page, or by a Web browser client application utilized to display such a Web page. For example, in one embodiment, a Web page including an interactive form made up of one or more form elements may be displayed by a Web browser client application. To “receive” data (e.g. from a user) via the displayed Web page in such an embodiment, input data is entered into the displayed form (e.g. by a user selecting or manipulating check boxes, radio buttons, or lists or by providing original text or other data) and the Web browser client application then makes the entered data available to Web server or CGI applications by placing or “posting” it into one or more environment or other variables or within the body of a CGI application request. The request or variables may then be parsed or manipulated to obtain local copies of the received data during data collection. It should be appreciated that implicitly-provided data such as “hidden” form fields or elements, or environment variables other than QUERY_STRING, although not explicitly entered via a displayed Web page, is also “received” by a Web page as defined herein when such implicitly-provided data is to be collected by or in an immediately succeeding CGI page or application.

In the illustrated embodiment, a determination is next made as to whether the current section is the last section in the current phase (block 508). This determination is made by the Phase Selector utilizing the Phase Control Configuration Data. If the last defined section of the current phase has not been reached, a new section is selected in the same manner as before (block 504) and the process continues from that point.

If the current section is the last one for the phase however, one or more CGI applications or “actions” associated with the selected phase and its component sections is executed on any appropriate collected user input data (block 510). In this portion of the illustrated method embodiment, the Phase Module Executor is notified that there is a desire to execute on the collected data. The Phase Module Executor then interfaces with the Phase Data Collector, the Phase Selector, and the Phase Control Configuration Data to determine what and how much data is going to be executed upon. Once this determination is completed, the Phase Module Executor then makes calls into the Phase/Section Module Execution Backend in order to execute upon the data. A determination is then made by the Phase Selector utilizing the stored Phase Control Configuration Data whether or not the user has reached the last defined phase for the provided Web site (block 512). If not, a new phase is selected (block 502) and the process is continued from that point. Otherwise, if the last defined phase for the Web site has been dispatched, the process terminates (block 514).

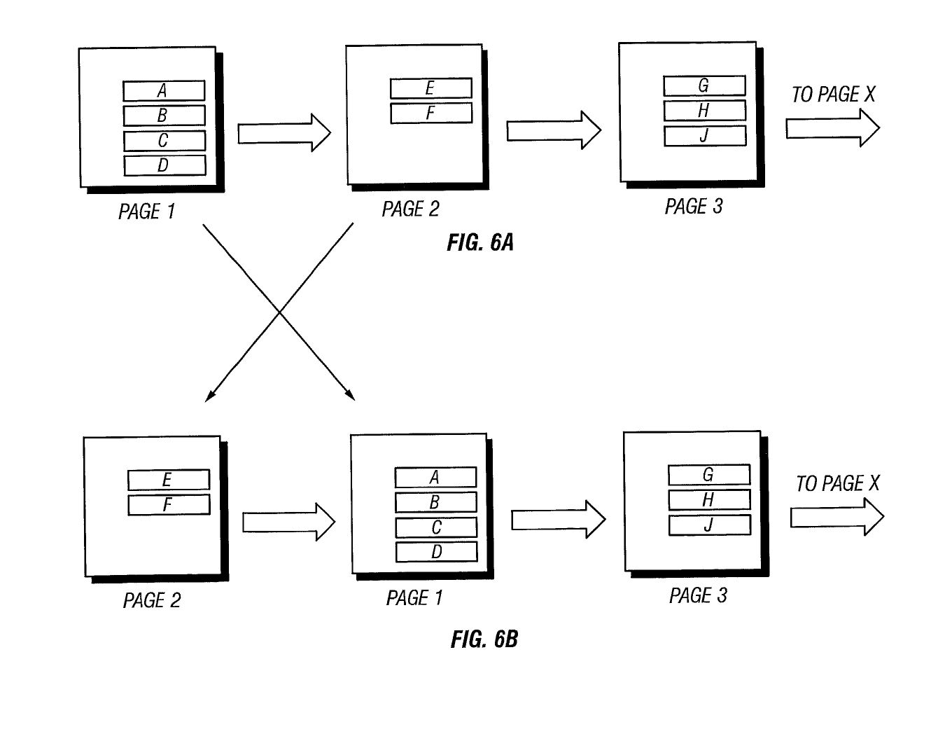

FIGS. 6a and 6b illustrate site map diagrams for a Web site prior to and following an alteration to Web site flow is made utilizing one embodiment of the present invention. A benefit of the illustrated embodiment is the freedom obtained to reorder CGI pages (as illustrated) as well as to add, remove, or modify them without affecting other CGI pages within a Web site. This is accomplished in one embodiment by giving control over CGI data collection to a single, shared phase control module.

Referring now to FIG. 6a, a site map diagram is illustrated for a Web site including CGI-pages where data is received by each page (i.e. Page 1 receives data A, B, C, D; Page 2 receives data E, F; and Page 3 receives data G, H, J). This received data may then be collected by a subsequent page in the site (i.e. data is received and sent from one page and collected or “read into” another). Using a conventional CGI system, the illustrated pages would, at a high level, be organized as follows:

| Page # | Data Received |
|---|---|
| 1 | 4 items (data A, data B, data C, data D) |
| 2 | 2 items (data B, data F) |
| 3 | 3 items (data G, data H, data J) |

| Page # | Data Collected |
|---|---|
| 1 | 0 items (empty, meaning it does not need to know about any |
| | incoming data) |
| 2 | 4 items (data A, data B, data C, data D) |
| 3 | 2 items (data E, data F) |

Referring now to FIG. 6b, the illustrated Web site is modified to rearrange the order of some of the exemplary CGI pages. Specifically, Page 1 and Page 2 are switched, so that data E & F are received (and collected) first, followed by data A, B, C, and D. Using conventional Web site management and CGI page structure, the impact on the individual CGI pages is summarized as follows (notice that even though the placement or order of Page 3 was not modified, changes are required in its data because the incoming data has changed):

| Page | Data Received | |
|---|---|---|
| # | BEFORE CHANGE | AFTER CHANGE |
| 1 | 4 items (data A, data B, data C, | 4 items (data A, data B, data C, |
| | data D) sent to Page 2 | data D) sent to Page 3 |
| 2 | 2 items (data E, data F) sent to | 2 items (data E, data F) sent to |
| | Page 3 | Page 1 |
| 3 | 3 items (data G, data H, data J) | no change |
| | sent to Page X | |

| Page | Data Collected | |
|---|---|---|
| # | BEFORE CHANGE | AFTER CHANGE |
| 1 | 0 items (empty, meaning it does | 2 items (data E, data F) |
| | not need to know about any | |
| | incoming data) | |
| 2 | 4 items (data A, data B, data C, | 0 items (empty, meaning it does |
| | data D) | not need to know about any |
| | | incoming data) |
| 3 | 2 items (data E, data F) | 4 items (data A, data B, data C, |
| | | data D) |

| | | |
|---|---|---|
| Total # Changes Needed | CGI Files | 3 out of 3 |
| | Code | 5 out of 6 |
| | Sections | |

By comparison, using a method embodiment of the present invention, Pages 1 and 2 of the illustrated example may be exchanged without any change to the individual CGI application files at all. The modification may be accomplished simply by modifying the Phase Control Configuration Data file as illustrated in the following table. This example plainly illustrates that implementing the method and system of the present invention significantly reduces the difficulty of creating, managing, and controlling Web sites including CGI application references as compared to conventional Web site management solutions.

| | | Conventional CGI | Method Embodiment |
|---|---|---|---|
| Total # | CGI Files | 3 out of 3 | 0 out of 3 |
| Changes | Code Sections | 5 out of 6 | 0 out of 6 |
| Needed | Configuration | N/A | 2 Lines of Phase |
| | Files | | Control Configuration |
| | | | Data File |

In the foregoing description, the present invention has been described with reference to specific exemplary embodiments thereof. It will be apparent however, that variations or modification of the exemplary embodiments described as well as alternative embodiments of the present invention may be implemented without departing from the broader spirit or scope of the present invention as defined in the appended claims. For example, it should be apparent that components of the phase control module may be combined such as the Phase Selector and Phase Dispatcher. The specification and drawings are accordingly to be regarded in an illustrative rather than a restrictive sense.

What is claimed is:

1. A method comprising:
storing phase control configuration data for a Web site, said Web site including a plurality of sections; and
dispatching a section of said plurality of sections utilizing said phase control configuration data.

2. The method as set forth in claim 1, said method further comprising modifying said Website in response to an alteration of said phase control configuration data.

3. The method as set forth in claim 1, wherein said phase control configuration data specifies an order of said plurality of sections and dispatching a section of said plurality of sections utilizing said phase control configuration data comprises:
selecting said section of said plurality of sections utilizing said order; and
displaying a Web page via a Web browser client application across a communications network in response to selecting said section of said plurality of sections.

4. The method as set forth in claim 3, wherein said Web site includes a plurality of phases and selecting said section of said plurality of sections utilizing said order comprises selecting a phase of said plurality of phases utilizing said phase control configuration data.

5. The method as set forth in claim 3, wherein displaying a Web page via a Web browser client application across a communications network comprises displaying a Web page including dynamic content via a Web browser client application.

6. The method as set forth in claim 3, wherein said phase control configuration data further specifies input data to be collected by said section of said plurality of sections and said method further comprises collecting said input data utilizing a phase control module application.

7. The method as set forth in claim 6, wherein collecting said input data utilizing a phase control module application comprises:
receiving said input data via said Web page; and
collecting said input data utilizing said phase control module application in response to receiving said input data via said Web page.

8. The method as set forth in claim 6, said method further comprising processing said input data utilizing said phase control module application.

9. The method as set forth in claim 8, wherein said phase control configuration data further specifies a Common Gateway Interface application associated with said section of said plurality of sections and processing said input data utilizing said phase control module application comprises executing said Common Gateway Interface application on said input data.

10. A machine-readable medium providing instructions, which when executed by a machine, cause said machine to perform a method comprising:
storing phase control configuration data for a Web site, said Web site including a plurality of sections; and
dispatching a section of said plurality of sections utilizing said phase control configuration data.

11. The machine-readable medium as set forth in claim 10, said method further comprising modifying said Web site in response to an alteration of said phase control configuration data.

12. The machine-readable medium as set forth in claim 10, wherein said phase control configuration data specifies an order of said plurality of sections and dispatching a section of said plurality of sections utilizing said phase control configuration data comprises:
selecting said section of said plurality of sections utilizing said order; and
displaying a Web page via a Web browser client application across a communications network in response to selecting said section of said plurality of sections.

13. The machine-readable medium as set forth in claim 12, wherein said phase control configuration data further specifies input data to be collected by said section of said plurality of sections and said method further comprises collecting said input data.

14. The machine-readable medium as set forth in claim 13, wherein collecting said input data comprises:
receiving said input data via said Web page; and
collecting said input data in response to receiving said input data via said Web page.

15. The machine-readable medium as set forth in claim 13, wherein said phase control configuration data further specifies a Common Gateway Interface application associated with said section of said plurality of sections and said method further comprises executing said Common Gateway Interface application on said input data.

16. An apparatus comprising:
a memory to store phase control configuration data for a Web site, said Web site including a plurality of sections; and
a phase dispatcher coupled to said memory to dispatch a section of said plurality of sections utilizing said phase control configuration data.

17. The apparatus as set forth in claim 16, wherein said phase control configuration data specifies an order of said plurality of sections and said apparatus further comprises a phase selector coupled to said memory to select said section of said plurality of sections utilizing said order.

18. The apparatus as set forth in claim 17, wherein said phase dispatcher further comprises a phase dispatcher to display a Web page via a Web browser client application across a communications network in response to a selection of said section of said plurality of sections.

19. The apparatus as set forth in claim 17, wherein said Web site includes a plurality of phases and said phase selector further comprises a phase selector to select a phase of said plurality of phases utilizing said phase control configuration data.

20. The apparatus as set forth in claim 18, wherein said phase control configuration data further specifies input data to be collected by said section of said plurality of sections and said apparatus further comprises a phase data collector coupled to said memory to collect said input data.

21. The apparatus as set forth in claim 20, wherein said memory comprises a memory to store phase module execution backend code and said apparatus further comprises a phase module executor coupled to said memory to execute said phase module execution backend code on said input data.

22. A computer system comprising:
a processor to process data and execute instructions;
a network interface coupled to said processor to couple said computer system to a communications network; and
a memory coupled to said processor to store phase control configuration data for a Web site, said Web site including a plurality of sections, and further to store a plurality of instructions which when executed by said processor cause said computer system to perform a method comprising dispatching a section of said plurality of sections utilizing said phase control configuration data.

23. The computer system as set forth in claim 22, wherein said method further comprises modifying said Web site in response to an alteration of said phase control configuration data.

24. The computer system as set forth in claim 22, wherein said phase control configuration data specifies an order of said plurality of sections and dispatching a section of said plurality of sections utilizing said phase control configuration data comprises:
selecting said section of said plurality of sections utilizing said order; and
displaying a Web page via a Web browser client application across said communications network in response to selecting said section of said plurality of sections.

25. The computer system as set forth in claim 24, wherein said Web site includes a plurality of phases and selecting said section of said plurality of sections utilizing said order comprises selecting a phase of said plurality of phases utilizing said phase control configuration data.

26. The computer system as set forth in claim 24, wherein displaying a Web page via a Web browser client application across said communications network comprises displaying a Web page including dynamic content via a Web browser client application.

27. The computer system as set forth in claim 24, wherein said phase control configuration data further specifies input data to be collected by said section of said plurality of sections and said method further comprises collecting said input data.

28. The computer system as set forth in claim 27, wherein collecting said input data comprises:
receiving said input data via said Web page; and
collecting said input data in response to receiving said input data via said Web page.

29. The computer system as set forth in claim 27, wherein said phase control configuration data further specifies a Common Gateway Interface application associated with said section of said plurality of sections and said method further comprises executing said Common Gateway Interface application on said input data.

30. The computer system as set forth in claim 22, wherein said computer system comprises a network attached storage device.
